(19) United States
(12) Patent Application Publication
(10) Pub. No.: US 2008/0297819 A1
(43) Pub. Date: Dec. 4, 2008

(54) SERVO CONTROL APPARATUS IN OPTICAL DISC DEVICE AND METHOD OF CONTROLLING SERVO

(75) Inventors: Soo-yong KIM, Suwon-si (KR); Seok-min YUN, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/128,027

(22) Filed: May 28, 2008

(30) Foreign Application Priority Data
May 29, 2007 (KR) 10-2007-0052197

(51) Int. Cl. G06F 15/00

(52) U.S. Cl. 358/1.9

(57) ABSTRACT

A servo control apparatus in an optical disc device and a method of controlling a servo are provided. When an image is printed on a surface of an optical disc, an irregular reflective surface results. A servo control apparatus that is adapted for such irregular surfaces includes: an optical pick-up unit configured to output an error detection signal, the error detection signal associated with a positional error of an objective lens, the positional error associated with light that is reflected from an optical disc; a signal compensation unit coupled to the optical pick-up unit, the signal compensation unit configured to amplify the error detection signal to produce an amplified error detection signal; a filter coupled to the signal compensation signal, the filter configured to remove a noise component from the amplified error detection signal to produce a filtered error detection signal; and a control unit coupled to the filter, the control unit configured to output a control signal to a positional actuator associated with the objective lens based on the filtered error detection signal.

### CROSS-REFERENCE TO RELATED PATENT APPLICATION

This application claims the benefit of Korean Patent Application No. 10-2007-0052197, filed on May 29, 2007, in the Korean Intellectual Property Office, the disclosure of which is incorporated herein in its entirety by reference.

### BACKGROUND OF THE INVENTION

1. Field of the Invention

The present invention relates generally to an optical disc device, and more particularly, but without limitation, to a servo control apparatus in an optical disc device and a method of controlling a servo.

2. Description of the Related Art

An optical disc is a flat circular disc used to store data in pits or bumps in a continuous groove. Common examples of optical discs are Digital Video Discs (DVDs), Compact Discs (CDs), Laserdiscs (LDs), Compact Disc plus Graphics (CD+G), and the like. Optical disc players reproduce video and/or audio data stored on an optical disc, and output the data via display screens, speakers, or other output devices.

The optical disc players use a light beam for reading data that is encoded in the pits or bumps. In order to accurately read data recorded on an optical disc, the light beam must be exactly focused on a signal surface of the optical disc. Conventionally, a servo control apparatus is used in optical disc players for this purpose. As used herein, a servo is a servomotor or a servomechanism. The servo control apparatus performs a focus servo operation or tracking servo operation. The focus servo operation moves an objective lens included in an optical pickup of the optical disc device upward and downward, and the tracking servo operation moves the objective lens right and left. The focus servo operation utilizes a focus error feedback signal to minimize the focus error signal. Likewise, the tracking servo operation utilizes a tracking error feedback signal to minimize the tracking error signal.

As described above, the servo control apparatus can efficiently read or write data on a surface of the optical disc. However, the conventional method has shortcomings where an image (or label) is printed on a surface of the optical disc. In particular, an image surface on the optical disc may cause irregular reflections. Such irregular reflections produce error signals with a relatively low amplitude and a noise component, rendering conventional feedback circuits and methods (described above) ineffective. A feed-forward method is disclosed in Europe Patent Publication No. 1705648. But such feed-forward approaches suffer from delayed processing time and lower quality reproduction. An improved servo control apparatus and method is therefore needed to better accommodate irregular reflections associated with image surfaces on optical discs.

### SUMMARY OF THE INVENTION

The invention provides a servo control apparatus having an improved feedback feature for reading and/or writing on an irregular reflective surface of an optical disc. The invention also provides a method of controlling a servo of the servo control apparatus.

According to an aspect of the invention, there is provided a servo control apparatus for controlling a servo during printing of an image on an irregular reflective surface of an optical disc, the servo control apparatus includes: an optical pick-up unit configured to output an error detection signal, the error detection signal associated with a positional error of an objective lens, the positional error associated with light that is reflected from an optical disc; a signal compensation unit coupled to the optical pick-up unit, the signal compensation unit configured to amplify the error detection signal to produce an amplified error detection signal; a filter coupled to the signal compensation signal, the filter configured to remove a noise component from the amplified error detection signal to produce a filtered error detection signal, and a control unit coupled to the filter, the control unit configured to output a control signal to a positional actuator associated with the objective lens based on the filtered error detection signal.

According to another aspect of the invention, there is provided a servo control apparatus that includes: an optical pick-up unit configured to output an error detection signal, the error detection signal associated with a positional error of an objective lens, the positional error associated with light that is reflected from an optical disc; a filter coupled to the optical pick-up unit, the filter configured to remove a noise component from the error detection signal to produce a filtered error detection signal; a signal compensation unit coupled to the filter, the signal compensation unit configured to amplify the filtered error detection signal to produce an amplified error detection signal; and a control unit coupled to the signal compensation unit, the control unit configured to output a control signal to a positional actuator associated with the objective lens based on the amplified error detection signal.

According to another aspect of the invention, there is provided a method for controlling a servo. The method includes: detecting an error signal indicating a degree of positional error in an objective lens based on light reflected from an optical disc; amplifying the error signal to produce an amplified error signal; and adjusting a position of the objective lens in response to the amplified error signal.

### BRIEF DESCRIPTION OF THE DRAWINGS

The above and other features and advantages of the invention will become more apparent by describing in detail exemplary embodiments thereof with reference to the attached drawings in which:

FIG. 1 is a block diagram of a servo control apparatus according to an embodiment of the present invention;

FIG. 2 is a flowchart illustrating a method of controlling a servo according to an embodiment of the present invention;

FIGS. 3A through 3C are waveform diagrams illustrating variation of an error signal according to an operation of the servo control apparatus shown in FIG. 1;

FIG. 4 is a block diagram of a servo control apparatus according to another embodiment of the present invention; and

FIGS. 5A through 5C are waveform diagrams illustrating variation of an error signal according to an operation of the servo control apparatus shown in FIG. 4.

### DESCRIPTION OF EMBODIMENTS

Hereinafter, the invention will be described in detail by explaining exemplary embodiments of the invention with reference to the attached drawings. Like reference numerals in the drawings denote like elements.

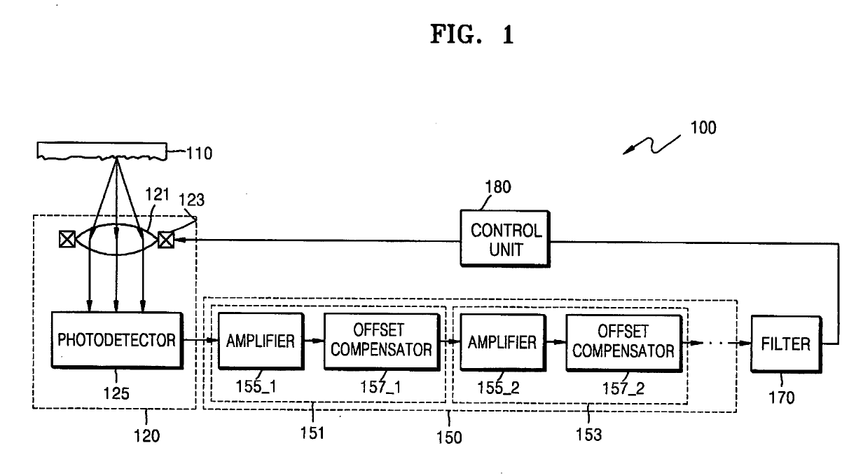

FIG. 1 is a block diagram of a servo control apparatus 100 according to an embodiment of the present invention.

Referring to FIG. 1, the servo control apparatus 100 includes an optical pickup unit 120, a signal compensation unit 150, a filter 170, and a control unit 180. The servo control apparatus 100 is configured to efficiently control a servo, in the case where an image is printed on a surface of an optical disc 110.

The optical pickup unit 120 outputs an error signal, such as a focus error signal indicating a degree of an error according to a position of an objective lens 121, by using a reflected light from an irregular reflective surface such, as an image surface of the optical disc 110. The signal compensation unit 150 amplifies the error signal output from the optical pickup unit 120 to a predetermined level and then outputs the amplified error signal to the filter 170. The filter 170 removes a noise component of the amplified error signal that is the signal output from the signal compensation unit 150. In response to the signal output from the filter 170, the control unit 180 adjusts a position of the objective lens 121 so as to reduce an error signal that is to be output from the optical pickup unit 120.

The optical pickup unit 120 generally may include a laser diode (not shown), a beam splitter (not shown), the objective lens 121, an actuator 123, and a photodetector 125. In operation, a light beam emitted from the laser diode (not shown) is divided by the beam splitter (not shown), and the objective lens 121 concentrates a spot (e.g., a focal point) of the divided light beam. The actuator 123 adjusts a position of the objective lens 121 so that the spot is located in a desired place on the optical disc 110. A light beam reflected from a surface of the optical disc 110 is detected by the photodetector 125, as shown in FIG. 1.

The photodetector 125 may include a division plate (not shown), and may generally detect an error signal by using an astigmatic method. The division plate may be divided into four quadrants, each of which is denoted as A, B, C, and, D in clockwise order from the top left. An output of each quadrant may be denoted as VA, VB, VC, and VD. Using this construct, the astigmatic method may produce a focus error signal using Equation 1 below.

focus error signal=(VA+VC)−(VB+VD) (1)

The astigmatic method is well known to those of ordinary skill in the art, and therefore further description will be omitted here.

The signal compensation unit 150 may include one or more signal compensation stages 151 and 153. Each of the signal compensation stages 151 and 153 may include an amplification unit (amplifier) and an offset compensation unit (offset compensator). For example, in the illustrated embodiment, the signal compensation stage 151 includes amplifier 155_1 and offset compensator 157_1. Likewise, the signal compensation stage 153 includes amplifier 155_2 and offset compensator 157_2. As indicated in FIG. 1, the signal compensation unit 150 may include other signal compensation stages in addition to signal compensation stages 151 and 153.

Since the amount of reflection caused by an image surface may be very small, the amplitude of an error signal received by the signal compensation unit 150 may also be relatively small. Thus, the amplifiers 155_1 and 155_2 amplify a voltage of the error signal to a much larger voltage. For instance, in total, the signal compensation unit 150 may amplify the error signal that is output from the optical pick-up unit 120 by a factor of 100. Amplification units 155_1 and 155_2 operate together to achieve the final desired level of amplification.

The offset compensators 157_1 and 157_2 compensate for an offset caused by operation of the amplifiers 155_1 and 155_2, respectively. The offset may be, for example, a direct current (DC) offset in an amplified signal resulting from manufacturing variations, temperature influences, or other factors associated with the amplifiers 155_1 and 155_2. In signal compensation stage 151, the offset compensator 157_1 compensates for an offset caused by the amplifier 155_1. In signal compensation stage 153, the offset compensator 157_2 compensates for an offset caused by the amplifier 155_2.

Because the image surface of the optical disc 110 has an irregular reflective surface, the reflected light may have many noise components. The filter 170 removes a noise component of the error signal. The filter 170 may be a low pass filter, and more preferably, a second order low pass filter.

The control unit 180 adjusts a position of the objective lens 121 by driving the actuator 120. Such repositioning of the objective lens 121 causes the optical pickup unit 120 to output a changed error signal. The signal compensation unit 150, the filter 170, and the control unit 180 again perform the same operations described above. Thus, although an image printed on the optical disc 110 is associated with an irregular reflective surface, the servo control apparatus 100 may sufficiently control a servo by using a feedback method.

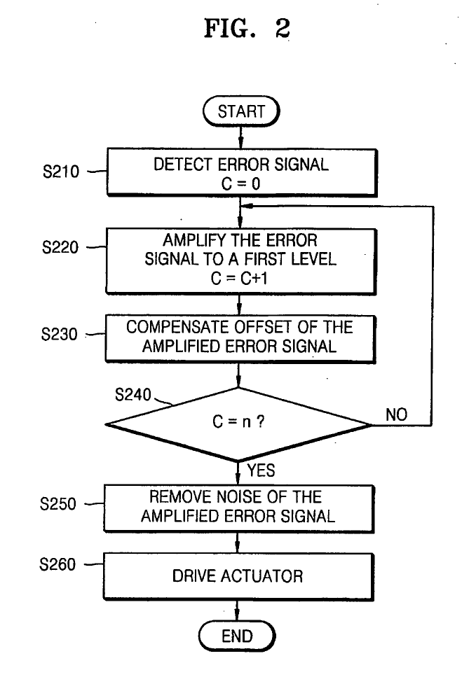

FIG. 2 is a flowchart illustrating a method of controlling a servo according to an embodiment of the present invention.

Referring to FIGS. 1 and 2, the optical pickup unit 120 detects an error signal indicating a degree of error associated with the position of the objective lens 121 in operation S210. An amplification unit amplifies the error signal to a first level in operation S220. An offset compensator compensates an offset of the amplified error signal in operation S230.

The signal compensation unit 150 may have multiple signal compensation stages. Thus, the operation of amplifying the error signal (operation S220) and the operation of compensating for the offset (operation S230) may be performed n times (where n is a natural number). Accordingly, at conditional operation S240, the process either returns to operation S220 or advances to operation S250.

The filter 170 removes noise from the amplified error signal in operation S250. The control unit 180 drives the actuator 123 to adjust a position of the objective lens 121 in operation S260. The process may then terminate, or operations S210 through S260 may be repeated.

Variations to the process illustrated in FIG. 2 and described above are possible. For example, although the process is described above with reference to the apparatus illustrated in FIG. 1, the process in FIG. 2 could be implemented with different components, according to design choice.

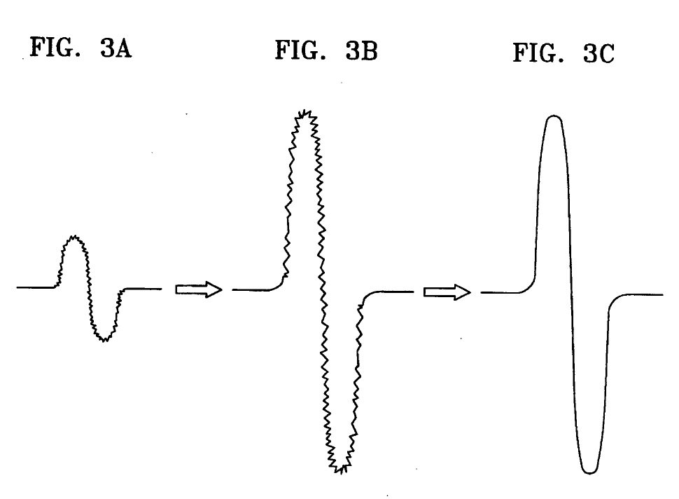

FIGS. 3A through 3C are waveform diagrams illustrating variation of an error signal according to an operation of the servo control apparatus 100 shown in FIG. 1. The waveforms in FIGS. 3A through 3C are not necessarily drawn to scale.

FIG. 3A is a waveform of an error signal output from the optical pickup unit 120. Since at least a portion of the optical disc 110 may have an irregular reflective surface, the error signal output from the optical pickup unit 120 may be small in amplitude with many noise components. FIG. 3B is a waveform of an error signal output from the signal compensation unit 150. The signal compensation unit 150 amplifies an input error signal to a predetermined level, and compensates for an offset of the input error signal. Thus, the waveform shown in FIG. 3B is an amplified version of the waveform shown in FIG. 3A. FIG. 3C is a waveform of an error signal output from the filter 170. The filter 170 removes noise components from the amplified error signal that is input to the filter 170. Therefore the waveform shown in FIG. 3C is smoother (less noisy) than the waveform shown in FIG. 3B.

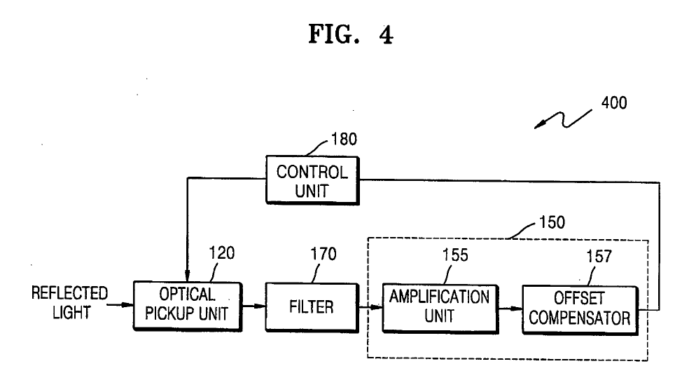

FIG. 4 is a block diagram of a servo control apparatus 400 according to another embodiment of the present invention.

Like the servo control apparatus 100 shown in FIG. 1, the servo control apparatus 400 shown in FIG. 4 includes the optical pickup unit 120, the filter 170, the signal compensation unit 150, and the control unit 180. The signal compensation unit 150 may include one or more signal compensation stages, and each signal compensation stage may include an amplification unit 155 and an offset compensator 157.

In the servo control apparatus 400, however, the filter 170 is coupled before the signal compensation unit 150. Thus, noise is removed from the error signal prior to amplification. As the servo control apparatus 400 otherwise operates similarly to the servo control apparatus 100 shown in FIG. 1, only a brief description of the operation is provided below.

An image printed on the surface of the optical disc 110 may produce irregular light reflections. The optical pickup unit 120 is configured to output an error signal to the filter 170 indicating a degree of an error associated with the position of the objective lens 121. The filter 170 is configured to remove a noise component associated with the error signal. The amplification unit 155 of the signal compensation unit 150 amplifies the error signal, and the offset compensator 157 compensates for an offset caused by the amplification. The control unit 180 adjusts the position of the objective lens 121 by driving the actuator 123 so as to reduce an error signal that is to be output from the optical pickup unit 120.

The servo control apparatus 400 enables a variation of the method illustrated in FIG. 2. In particular, the method in FIG. 2 may be modified so that operation S250 is performed after the detection operation S210 and before the amplification operation S220. In such an embodiment, when the result of conditional step S250 is satisfied, the process advances directly to actuation step S260.

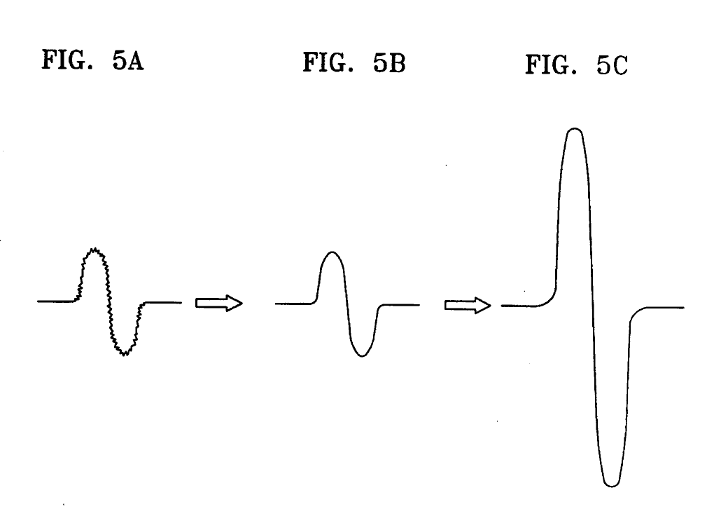

FIGS. 5A through 5C are waveform diagrams illustrating variation of an error signal according to an operation of the servo control apparatus 400 shown in FIG. 4. The waveforms in FIGS. 5A through 5C are not necessarily drawn to scale.

FIG. A is a waveform of an error signal output from the optical pickup unit 120. Since an image surface of the optical disc 110 has an irregular reflective surface, the error signal waveform output from the optical pickup unit 120 may be relatively small in amplitude and may contain a noise component. FIG. 5B is a waveform of an error signal output from the filter 170. Since the filter 170 removes noise of an input error signal, the waveform shown in FIG. 5B is smoother (less noisy) than the waveform shown in FIG. 5A. FIG. 5C is a waveform of an error signal output from the signal compensation unit 150. The signal compensation unit 150 amplifies a received signal and compensates for an offset caused by the amplification. Thus, the waveform in FIG. 5C has a higher amplitude than the waveform shown in FIG. 5B.

Comparing FIGS. 3C and 5C, waveforms of error signals input to the control unit 180 are substantially similar for the servo control apparatus 100 and the servo control apparatus 400.

Embodiments of the invention thus provide apparatuses and methods for controlling a servo. The apparatuses and methods disclosed herein are especially adapted to correcting positional errors caused by irregular reflective surfaces on optical discs. One embodiment of the invention is particularly efficient in controlling a servo when an image is being printed on the label surface of an optical disc. The label surface may be an irregular reflective surface portion of the optical disc.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A servo control apparatus for controlling a servo during printing of an image on an irregular reflective surface of an optical disc, the servo control apparatus comprising:
an optical pick-up unit configured to output an error detection signal, the error detection signal associated with a positional error of an objective lens, the positional error associated with light that is reflected from the optical disc;
a signal compensation unit coupled to the optical pick-up unit, the signal compensation unit configured to amplify the error detection signal to produce an amplified error detection signal;
a filter coupled to the signal compensation signal, the filter configured to remove a noise component from the amplified error detection signal to produce a filtered error detection signal; and
a control unit coupled to the filter, the control unit configured to output a control signal to a positional actuator associated with the objective lens based on the filtered error detection signal.

2. The servo control apparatus of claim 1, wherein the signal compensation unit includes at least one signal compensation stage, each of the at least one signal compensation stages having an amplifier coupled to an offset compensator, the offset compensator configured to compensate for an offset generated by the amplifier during operation.

3. The servo control apparatus of claim 1, wherein the signal compensation unit includes a plurality of signal compensation stages, each of the plurality of signal compensation stages having an amplifier coupled to an offset compensator, the offset compensator configured to compensate for an offset generated by the amplifier during operation.

4. The servo control apparatus of claim 3, wherein the signal compensation unit is configured to amplify the error detection signal by a factor of at least 100.

5. The servo control apparatus of claim 1, wherein the filter is a low pass filter.

6. The servo control apparatus of claim 5, wherein the filter is a second order low pass filter.

7. The servo control apparatus of claim 1, wherein the error detection signal is a focus error signal.

8. A servo control apparatus comprising:
an optical pick-up unit configured to output an error detection signal, the error detection signal associated with a positional error of an objective lens, the positional error associated with light that is reflected from an optical disc;
a filter coupled to the optical pick-up unit, the filter configured to remove a noise component from the error detection signal to produce a filtered error detection signal;
a signal compensation unit coupled to the filter, the signal compensation unit configured to amplify the filtered error detection signal to produce an amplified error detection signal; and
a control unit coupled to the signal compensation unit, the control unit configured to output a control signal to a positional actuator associated with the objective lens based on the amplified error detection signal.

9. The servo control apparatus of claim 8, wherein the signal compensation unit includes at least one signal compensation stage, each of the at least one signal compensation stages having an amplifier coupled to an offset compensator, the offset compensator configured to compensate for an offset generated by the amplifier during operation.

10. The servo control apparatus of claim 8, wherein the signal compensation unit includes a plurality of signal compensation stages, each of the plurality of signal compensation stages having an amplifier coupled to an offset compensator, the offset compensator configured to compensate for an offset generated by the amplifier during operation.

11. The servo control apparatus of claim 10, wherein the signal compensation unit is configured to amplify the error detection signal by a factor of at least 100.

12. The servo control apparatus of claim 8, wherein the filter is a low pass filter.

13. The servo control apparatus of claim 8, wherein the filter is a second order low pass filter.

14. The servo control apparatus of claim 8, wherein the error detection signal is a focus error signal.

15. A method of controlling a servo, the method comprising:
detecting an error signal indicating a degree of positional error in an objective lens based on light reflected from an optical disc;
amplifying the error signal to produce an amplified error signal; and
adjusting a position of the objective lens in response to the amplified error signal.

16. The method of claim 15, further comprising, after the amplifying and before the adjusting, compensating the amplified error signal for an offset caused by the amplifying.

17. The method of claim 15, wherein a peak-to-peak amplitude of the amplified error signal is at least 100 times the peak-to-peak amplitude of the error signal.

18. The method of claim 15, further comprising, after the amplifying and before the adjusting, removing a noise component of the amplified error signal.

19. The method of claim 15, wherein the error signal is a focus error signal.

20. The method of claim 15, wherein the adjusting the location includes driving an actuator coupled to the objective lens in response to the amplified error signal.
